(19) United States
(12) Patent Application Publication
(10) Pub. No.: US 2024/0017869 A1
(43) Pub. Date: Jan. 18, 2024

(54) LABELING MACHINE

(71) Applicant: P.E. LABELLERS S.P.A., Porto Mantovano (IT)

(72) Inventor: Riccardo BARDINI, Torri Del Benaco (IT)

(21) Appl. No.: 18/039,581

(22) PCT Filed: Dec. 13, 2021
(86) PCT No.: PCT/EP2021/085390

§ 371 Date: May 31, 2023

(30) Foreign Application Priority Data
Dec. 15, 2020 (IT) 102020000030809

(51) Int. Cl. B65C 9/18; B65C 9/02; B65C 9/40

(52) U.S. Cl. CPC B65C 9/1819; B65C 9/02; B65C 9/40

(57) ABSTRACT

A labeling machine includes a conveyor of containers to be labeled along an advancement path and at least one labeling assembly arranged along the advancement path of the containers; the labeling assembly includes an unwinding assembly for a label ribbon, on which multiple labels are printed in succession, and at least one conveyance drum designed to receive the label ribbon and/or the labels obtained by cutting the label ribbon. At the peripheral region of the conveyance drum there is a plurality of sliders, which are mutually angularly spaced around the axis of the conveyance drum. At least one of the sliders has resting regions designed to engage by contact the label ribbon and/or the labels, which are adapted to apply, with respect to the label ribbon and/or the labels, mutually different attraction forces toward the corresponding slider.

The present invention relates to a labeling machine.

Labeling machines are known which allow to apply to containers labels obtained by cutting a continuous label ribbon that is unwound from a reel.

The label ribbon may have pre-applied portions of glue on the face of the labels designed to make contact with the containers or may be free from glue and in this case the machine is equipped with an assembly for applying glue to the labels.

In general, known labeling machines comprise a conveyor of the containers to be labeled, which allows the advancement of the containers along a preset path and usually is constituted by a rotating carousel provided, at its peripheral region, with rotatable plates for supporting the individual containers which allow to rotate the containers about their axes.

Labeling machines have, moreover, along the advancement path of the containers and more precisely at the peripheral region of the carousel, at least one labeling assembly which allows to apply a respective label to each individual container arriving from the carousel.

The labeling assembly comprises in turn an unwinding assembly which allows to pick up the label ribbon from its reel, making it pass through an alignment and tension adjustment device.

Downstream of the unwinding assembly there is a conveyance drum designed to receive on its lateral surface the labels obtained by cutting the label ribbon in order to deliver them to the respective containers to be labeled.

Said conveyance drum is usually provided, on its own lateral surface, with ports which communicate with air suction means which ensure the retention of the labels in adherence against the lateral surface of the conveyance drum and has, moreover, along the perimeter of the conveyance drum, a plurality of resting blocks, commonly termed sliders or also buffers or pads, which have at least one portion that protrudes with respect to the lateral surface of said conveyance drum and are designed to receive the leading and trailing ends of the labels.

Suction ports are usually present in the sliders as well and communicate with the suction means, in order to ensure the retention of the ends of the label resting on the sliders.

More particularly, in some types of labeling machine the label ribbon, in output from the unwinding assembly, is picked up by a cutting roller, provided with blades integral therewith, which by operating in cooperation with a blade which is fixed with respect to the supporting structure of the machine cut the label ribbon between one label and the other and deliver the labels separated from the label ribbon to the conveyance drum, which carries them in adherence on the corresponding container which is supported by the carousel and therefore is termed, in the jargon, “transfer drum”.

In other known labeling machines, instead, the label ribbon fed by the unwinding assembly is picked up directly by the conveyance drum, which in this case is provided with blades designed to cut the label ribbon in the separation region between one label and the next and retains the labels obtained after cutting in order to bring them into contact with the corresponding containers arriving from the carousel. The conveyance drum of machines of this type is indeed termed “cutting and transfer drum”.

In machines designed to process label ribbons without pre-applied glue, the glue application assembly is usually constituted by a spreading roller, laterally adjacent to the conveyance drum, which allows to apply respective strips of glue on the leading and trailing ends of the labels that are resting on the sliders, when said sliders pass at the spreading roller, during the rotation of said conveyance drum.

The various types of labeling machine described above have, during their operation, steps in which there is a sliding of the conveyance drum and, therefore, also of the sliders integral therewith, on the label ribbon or on the labels that are transferred to said conveyance drum, and steps in which the label ribbon or the labels must instead move integrally with the lateral surface of the conveyance drum.

Current machines are not fully satisfactory in allowing adequate sliding of the sliders on the label ribbon or labels in the steps in which the sliding of the conveyance drum with respect to the label ribbon or labels is required and in ensuring, at the same time, an optimum retention of the label ribbon or labels to the conveyance drum by the sliders in the steps in which instead the label ribbon or labels must be perfectly integral with the movement of the conveyance drum.

The aim of the present invention is to provide a labeling machine that is capable of improving the background art in one or more of the aspects mentioned above.

Within the scope of this aim, an object of the invention is to provide a labeling machine in which the sliders mounted on the conveyance drum of the machine are capable of operating in an optimum manner both during the steps of sliding of the conveyance drum on the label ribbon or on the labels and during the steps in which the retention of the label ribbon or of the labels integrally to the conveyance drum is required.

Another object of the invention is to provide a labeling machine that is capable of giving the greatest assurances of reliability and safety.

Moreover, an object of the present invention is to overcome the drawbacks of the background art in a manner that is alternative to any existing solutions.

Not least object of the invention is to provide a labeling machine that is relatively easy to provide and can be manufactured at competitive costs.

This aim and these and other objects which will become better apparent hereinafter are achieved by a labeling machine according to claim 1, optionally provided with one or more of the characteristics of the dependent claims.

Further characteristics and advantages of the invention will become better apparent from the description of some preferred but not exclusive embodiments, of the labeling machine according to the invention, illustrated by way of non-limiting example in the accompanying drawings, wherein:

FIG. 1 is a perspective view of the labeling machine according to the invention in a first embodiment thereof;

FIG. 2 is a perspective view of a conveyance drum of the machine according to the invention;

FIG. 3 is a front view, partially in phantom lines, of an embodiment of a slider of a conveyance drum of the machine according to the invention;

FIG. 4 is a rear view of the slider of FIG. 3;

FIG. 5 is a front view of the slider according to a possible constructive variation thereof;

FIGS. 6, 7, and 8 are schematic top views of a sequence of operating steps of the embodiment of the machine according to the invention of FIG. 1,

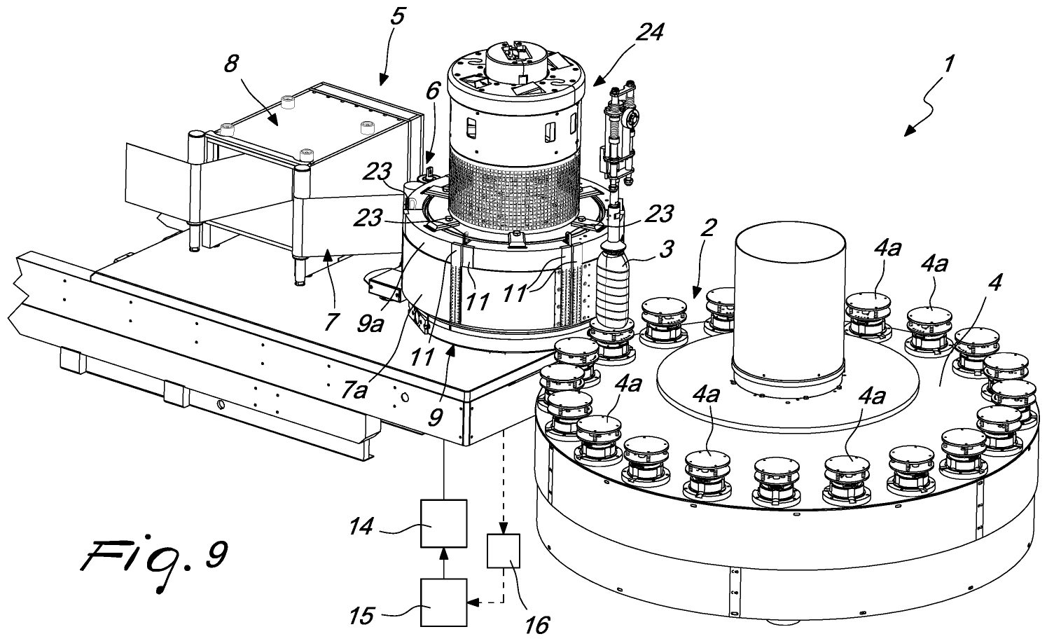

FIG. 9 is a perspective view of a second embodiment of the machine according to the invention;

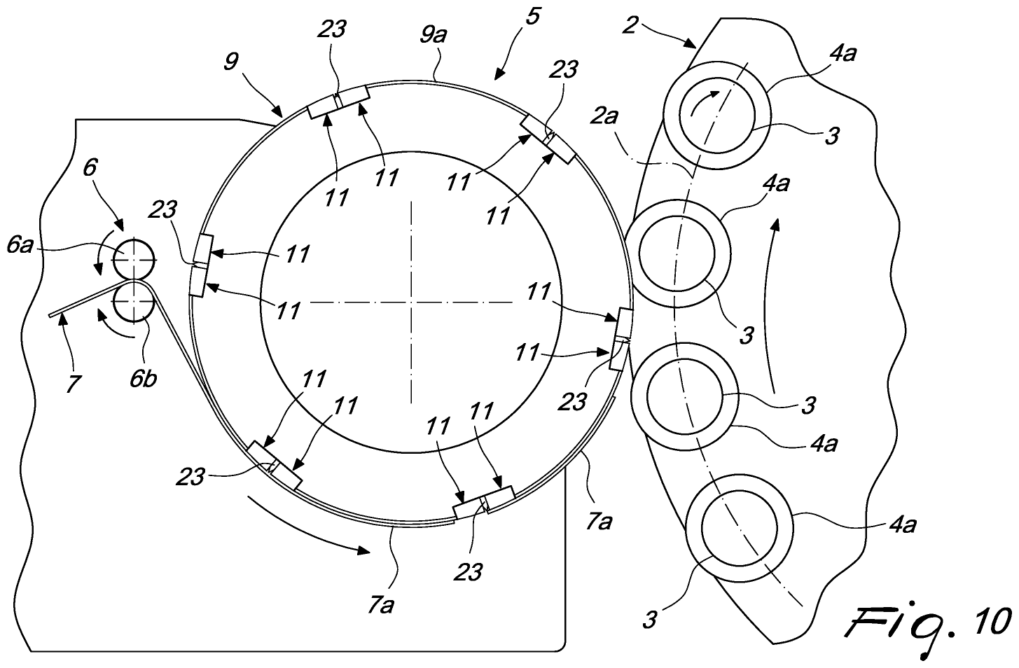

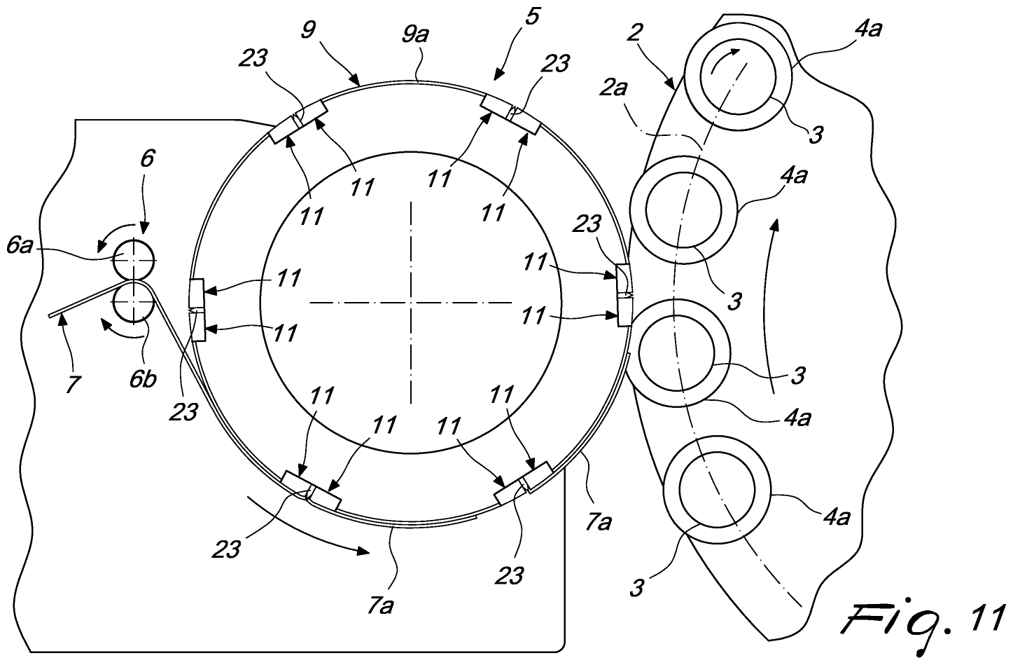

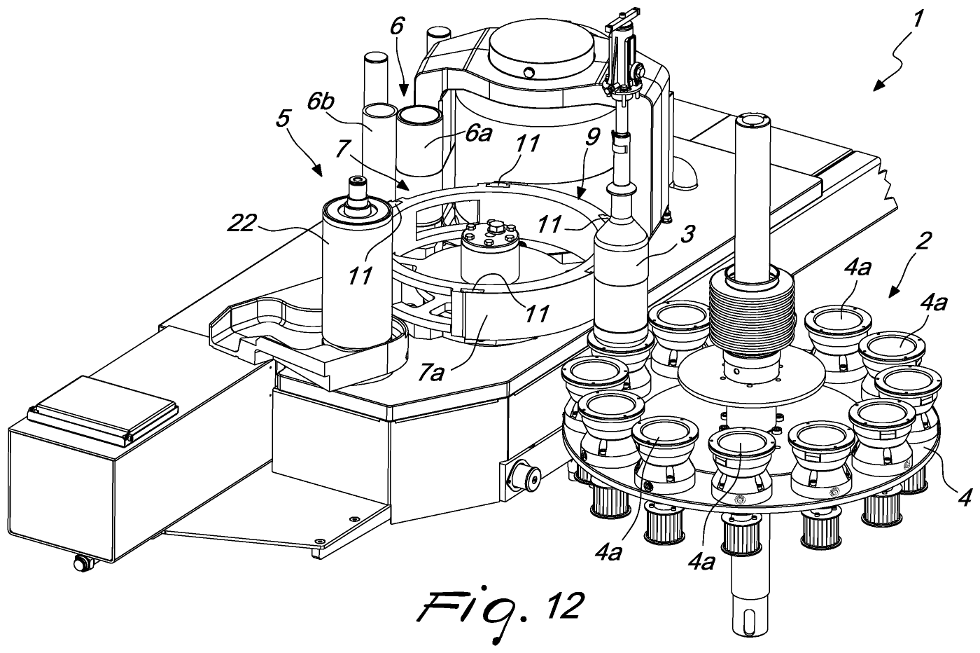

FIGS. 10 and 11 are schematic and sequential top plan views of two different steps of the operation of the second embodiment of the machine according to the invention;

FIG. 12 is a perspective view of a third embodiment of the machine according to the invention;

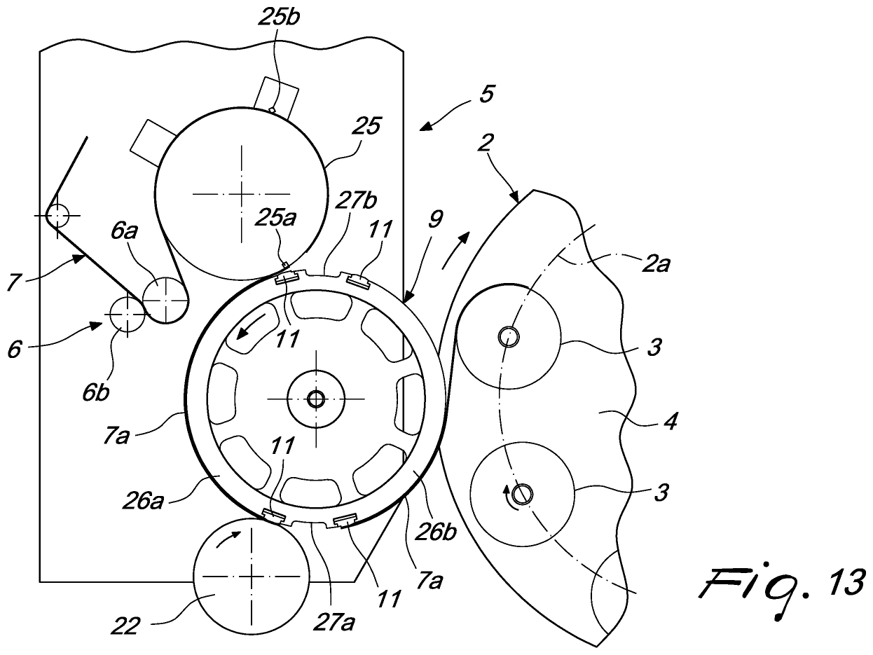

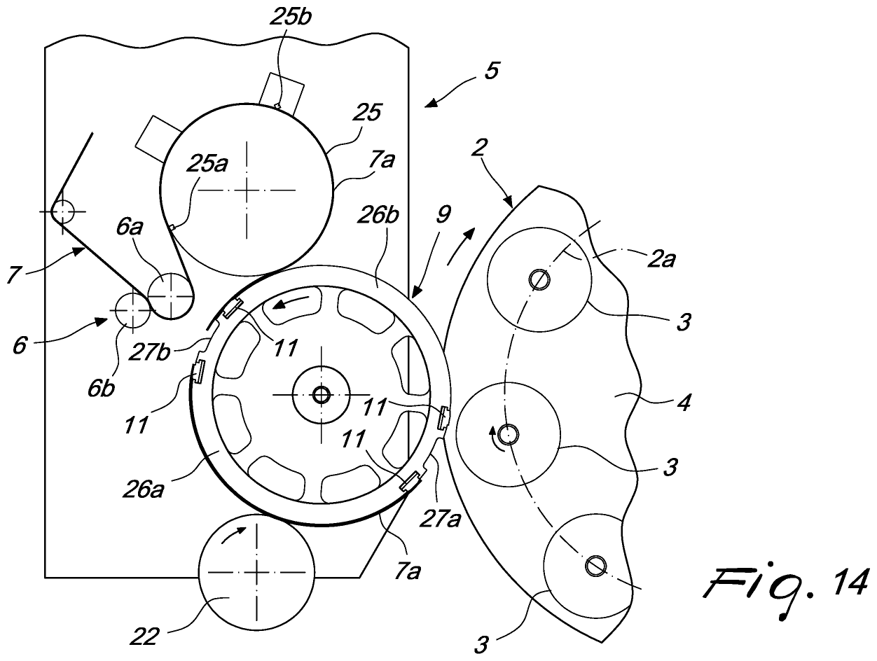

FIGS. 13, 14 and 15 are schematic and sequential top plan views of a sequence of some steps of the operation of the third embodiment of the machine according to the invention;

FIG. 16 is a schematic sectional view, taken along a diametrical plane, of a conveyance drum of the machine according to the invention, in one possible embodiment.

With reference to the cited figures, the labeling machine according to the invention, generally designated by the reference numeral 1, comprises a conveyor 2 for conveying the containers 3 to be labeled along an advancement path 2a which is conveniently constituted by a carousel 4 provided peripherally with rotating plates 4a, which each support a single container 3.

Along the advancement path 2a of the containers 3 to be labeled there is at least one labeling assembly 5, which comprises an unwinding assembly 6 which is constituted for example by a pair of mutually opposite traction rollers 6a, 6b and allows to draw from a reel, not shown, a label ribbon 7 which bears, printed thereon with continuity, a plurality of labels 7a which are designed to be separated from the label ribbon 7, by cutting said label ribbon between one label 7a and the next label 7a.

The label ribbon 7 unwound from the reel, by virtue of the unwinding assembly 6, is also passed conveniently through means that allow to adjust its tension and to ensure its alignment, which comprise for example a per se known tensioning device 8, which allows to create a loop of variable extent in the label ribbon 7.

It should be noted that the label ribbon 7 can be free from pre-applied glue, as in the case of the embodiments shown in particular in FIG. 1 and in FIG. 12, and in this case means better described hereinafter for applying the glue on the labels 7a are provided, or it may be of the pre-adhesive type, as in the case of the embodiment shown in particular in FIG. 9.

The labeling assembly 5 is furthermore provided with at least one conveyance drum 9, which is designed to receive on its own lateral surface 9a the label ribbon 7 and/or the labels 7a obtained by cutting from the label ribbon 7.

For this purpose, the conveyance drum 9 is conveniently provided, on its own lateral surface 9a, with suction ports 10, which allow to keep the label ribbon 7 in adherence on said lateral surface of the conveyance drum 9.

Moreover, multiple sliders 11 are distributed along the peripheral region of the conveyance drum 9, are designed to receive thereon the label ribbon 7 or the labels 7a, and each have at least one portion in relief outward with respect to the lateral surface 9a of the conveyance drum 9 in order to allows the sliders 11 to interact with the means for applying the glue on the labels 7a, if present, and/or with the containers 3 in order to make the labels 7a adhere thereon, as in the embodiment of FIG. 12.

Advantageously, each slider 11 is constituted in practice by a body, which is coupled, preferably detachably, to the conveyance drum 9, by means of its accommodation in a corresponding receptacle formed at the peripheral region of the conveyance drum 9, and which may be advantageously made of a different material with respect to the material of which the lateral surface 9a of the conveyance drum 9 is made.

The particularity of the invention resides in that at least one of the sliders 11, and more preferably each one of the sliders 11, has, within itself at least on its own external surface 11a, designed to come into contact with the label ribbon 7 and/or the labels 7a, resting regions 12, 13 and, more particularly, at least two different resting regions 12, 13, which can engaged by contact by the label ribbon 7 and/or by the labels 7a and are capable of applying, with respect to the label ribbon 7 and/or the labels 7a, mutually different attraction forces toward the corresponding slider 11.

In particular, the resting regions 12, 13 of each slider 11 have suction means which allow the resting regions 12, 13 to attract the label ribbon 7 and/or the labels 7a toward the corresponding slider 11.

More particularly, said suction means comprise advantageously, for each one of the resting regions 12, 13, respective suction openings, which are formed on the external surface 11a of the corresponding slider 11 that is designed to receive in resting contact the label ribbon 7 and/or the labels 7a and can be connected to air suction means 14, constituted conveniently by at least one vacuum source, as will be better explained also hereinafter.

Advantageously, the suction means of each of the resting regions 12, 13 are structured as to allow the resting regions 12, 13 to generate, with respect to each other, a different degree or level of vacuum, so as to be able to create mutually different attraction forces with respect to the label ribbon and/or the labels 7a.

In greater detail, the resting regions 12, 13 conveniently comprise at least one first resting region 12, adapted to generate a first degree of vacuum, and at least one second resting region 13, adapted to generate a second degree of vacuum, greater than the first degree of vacuum, so as to be able to apply a force of attraction with respect to the label ribbon 7 and/or the labels 7a that is greater than that of the first resting region 12.

Preferably, the first resting region 12, which constitutes in practice a region with a low degree of vacuum, has first suction openings 12a, while the second resting region 13, which constitutes, in practice, a region with a high degree of vacuum, has second suction openings 13a.

Advantageously, each first resting region 12 and each second resting region 13 can be activated selectively on command in order to generate the respective degree of vacuum as a function of the angular position of the corresponding slider 11, with respect to the axis of the conveyance drum 9, during the rotation of said conveyance drum, as will be better clarified hereinafter.

In particular, during the rotation of the conveyance drum 9 the first suction openings 12a and the second suction openings 13a may be alternately connected to the air suction means 14, depending on the position in which the corresponding slider 11 is located with respect to the axis of the conveyance drum 9.

More in detail, at first positions assumed during the rotation of the conveyance drum 9 by the corresponding slider 11 with respect to the axis of said conveyance drum, in which a sliding of the slider 11 with respect to the label ribbon 7 and/or the labels 7a is required, the first resting region 12 is activated while the second resting region 13 is deactivated and, more precisely, the first suction openings 12a are connected to the air suction means 14 and the second suction openings 13a are disconnected from the air suction means 14, while at second positions assumed during the rotation of the conveyance drum 9 by the corresponding slider 11 with respect to the axis of said conveyance drum, in which a retention by the slider 11 of the label ribbon 7 and/or the labels 7a is required, the second resting region 13 is activated, so that the second suction openings 13a are connected to the air suction means 14, while the first resting region 12 may be deactivated, so that the first suction openings 12a are disconnected from the air suction means 14, or may be kept activated, so that it also contributes to the retention of the label ribbon and/or of the labels 7a to the corresponding slider 11.

Conveniently, control means 15 may be provided which are constituted for example by an electronic control unit and are functionally connected to the air suction means 14 and conveniently to at least one sensor 16 for detecting the angular position of the sliders 11 of the conveyance drum 9 with respect to its axis.

Said control means 15 are designed to control the activation or deactivation of the resting regions 12 and 13, i.e., the activation or deactivation of the connection of the respective suction openings 12a and 13a to the air suction means 14, based on the angular position of the respective slider 11 with respect to the axis of the conveyance drum 9.

Advantageously, on each slider 11 there can be multiple first resting regions 12 and multiple second resting regions 13, arranged at mutually different portions of the corresponding slider 11.

Conveniently, it is possible to provide one or more first resting regions 12 located in a substantially central portion of the external surface 11a of each slider 11 designed to make contact with the label ribbon 7 and/or the labels 7a, while one or more second resting regions 13 can be provided which are advantageously located at peripheral portions of said surface.

More particularly, the first resting region or regions 12 are located at the portion or portions of the external surface 11a of the corresponding slider 11 that are more protruding or in relief from the lateral surface 9a of the conveyance drum 9 with respect to the remaining portion of said slider, while the second resting region or regions 13 can be arranged at portions of the corresponding slider 11 that are less protruding from the lateral surface 9a of the conveyance drum 9 with respect to the portions on which the first resting regions 12 are formed.

Conveniently, furthermore, the first resting regions 12, besides being located at a greater distance from the axis of the conveyance drum 9 than the second resting regions 13, are arranged on surfaces which are substantially planar or, optionally, have a smaller curvature than the lateral surface 9a of the conveyance drum 9, and the second resting regions 13 are arranged, at least partly, on surfaces which are inclined with respect to the surfaces on which the first resting regions 12 are formed.

According to one possible embodiment, the suction openings of the various resting regions 12, 13 are connected or can be connected to mutually different vacuum sources adapted to create a respective degree of vacuum.

In greater detail, in this embodiment said air suction means 14 comprise at least one first vacuum source 14a, which can be connected to the first suction openings 12a of the sliders 11, and at least one second vacuum source 14b, which can be connected to the second suction openings 13a of the sliders 11 and is capable of generating a greater degree of vacuum with respect to the degree of vacuum that can be generated by the first vacuum source 14a.

Also according to this embodiment, the first suction openings 12a of each slider 11 conveniently communicate with a first vacuum chamber 17a, formed on the side of the corresponding slider 11 that is designed to face the inside of the conveyance drum 9 and can be connected to the first vacuum source 14a, conveniently by means of a first communication channel 18a, while the second suction openings 13a communicate with a second vacuum chamber 17b, also formed on the side of the corresponding slider 11 that is designed to face the inside of the conveyance drum 9, which is separated hermetically from the first vacuum chamber 17a and furthermore can be connected to the second vacuum source 14b, conveniently by means of a second communication channel 18b, which is separated from the first communication channel 18a.

In this case, the selective activation of the first resting regions 12 or of the second resting regions 13 of a slider 11 may occur by means of the selective activation the first vacuum source 14a or of the second vacuum source 14b or by means of the selective connection of the first vacuum source 14a to the first suction openings 12a or of the second vacuum source 14b to the second vacuum openings 13a, so that in the angular positions of the corresponding slider 11 relative to the axis of the conveyance drum 9 in which the sliding of the slider 11 on the label ribbon 7 and/or on the labels 7a is required, the first suction openings 12a are connected to the first vacuum source 14a and the second suction openings 13a are disconnected from the second vacuum source 14b, while in the angular positions of the corresponding slider 11 relative to the axis of the conveyance drum 9 in which retention by the slider 11 of the label ribbon 7 and/or of the labels 7a is required, the second suction openings 13a are connected to the second vacuum source 14b and the first suction openings 12a can be connected or even disconnected, optionally, with respect to the first vacuum source 14a.

Conveniently, the selective activation of the first vacuum source 14a or of the second vacuum source 14b, as a function of the angular position of the sliders 11, may be driven by the control means 15, which, based on the signal that arrives from the detection sensor 16, may either activate the second vacuum source 14b and deactivate or keep activated the first vacuum source 14a or deactivate the second vacuum source 14b and activate or keep activated the first vacuum source 14a.

Advantageously, the selective connection of the first vacuum source 14a to the first suction openings 12a or of the second vacuum source 14b to the second vacuum openings 13a, as a function of the angular position of the sliders 11, also may be provided by the control means 15, which in this case, based on the signal that arrives from the detection sensor 16, may selectively actuate the opening or closing of a first electric valve 19a for the connection of the first suction openings 12a to the first vacuum source 14a and of a second electric valve 19b for the connection of the second suction openings 13a to the second vacuum source 14b.

According to a different embodiment, the air suction means 14 may comprise a single vacuum source, capable of generating a preset degree of vacuum, to which both the first suction openings 12a and the second suction openings 13a of each slider 11 can be connected.

In this case, as shown in particular in FIG. 5, the second suction openings 13a, which are present in the second resting region 13, have, at least at the external surface 11a of the corresponding slider 11, a larger dimensional extent with respect to the dimensional extent of the first suction openings 12a present in the first resting region 12.

In this way, although the first and second suction openings 12a and 13a are connected to a same vacuum source, the attraction force generated by the second resting region 13 with respect to the label ribbon 7 and/or the labels 7a is still greater than the attraction force generated by the first resting region 12, due to the greater dimensional extent of the second suction openings 13a with respect to the dimensional extent of the first suction openings 12a.

In particular, in this embodiment the second suction openings 13a can be provided by circular or oblong slots which are open on the external surface 11a of the corresponding slider 11 and communicate, on their bottom, with a respective hole 13b for connection to the vacuum source, while the first suction openings 12a can be provided by simple circular holes, open again on the external surface 11a of the corresponding slider and smaller in size with respect to the slots that provide the second suction openings 13a.

In this case, the selective activation of the first resting regions 12 or of the second resting regions 13 of a slider 11, depending on the angular position of said slider, may occur by selectively connecting the single vacuum source respectively to the first suction openings 12a or to the second suction openings 13a, depending on the position in which the slider 11 is located, during the rotation of the conveyance drum 9.

For example, the selective connection to the vacuum source of the first suction openings 12a or of the second suction openings 13a of a slider 11, based on the angular position assumed, during the rotation of the conveyance drum 9, by said slider with respect to the axis of the conveyance drum 9, may be obtained for example by means of circumferentially extended connection slots, not shown, which are located on a supporting base of the conveyance drum 9, are connected to the vacuum source, and to which the first and second suction openings 12a and 13a can be connected, respectively.

In particular, said connection slots are positioned so as to face the positions occupied by the sliders 11 during the rotation of the conveyance drum 9 and are arranged, with respect to each other, so as to allow, respectively, the connection with the vacuum source of the first suction openings 12a but not of the second suction openings 13a when the sliders 11 are, during the rotation of the conveyance drum 9, in the angular positions in which their sliding with respect to the label ribbon 7 or the labels 7a is required, and the connection with the vacuum source of the second suction openings 13a but not necessarily also of the first suction openings 12a when the sliders 11 are, during the rotation of the conveyance drum 9, in the angular positions in which retention of the label ribbon 7 or of the labels 7a by said sliders is required.

As an alternative, the selective connection to the vacuum source of the first or second suction openings 12a and 13a, as a function of the angular position of the sliders 11 with respect to the axis of the conveyance drum 9, may also be actuated by the control means 15, which allow, based on the signal arriving from the detection sensor 16, to actuate the selective opening or closing of electric valves which connect the vacuum source to the first and second suction openings 12a and 13a, respectively.

Nothing forbids providing also a further embodiment, in which the second suction openings 13a have a larger dimensional extent with respect to the first suction openings 12a and in which the first suction openings 12a can be connected to a first vacuum source 14a and the second suction openings 13 to a second vacuum source 14b, capable of generating a greater degree of vacuum than the first vacuum source 14a.

With reference now to a first embodiment of the machine according to the invention, shown in particular in FIG. 1, the conveyance drum 9 can be constituted by a cutting and transfer drum which is designed to receive from the unwinding assembly 6 the label ribbon 7 in order to cut it and bring the labels 7a separated after the cutting into contact with the respective containers 3 conveyed by the conveyor 2.

In this first embodiment, the conveyance drum 9 has a plurality of cutting devices 20, which are arranged so as to be mutually circumferentially spaced.

In particular, each one of said cutting devices 20 is arranged in a position directly behind a respective slider 11, with respect to the direction of rotation of the conveyance drum 9.

Conveniently, in this embodiment each cutting device 20 comprises a respective blade 20a accommodated in a suction chamber 21, which is open on the lateral surface 9a of the conveyance drum 9.

Said suction chamber 21 can be connected to a vacuum source, which can be optionally provided by the same air suction means 14 to which the suction openings 12a, 13a of the sliders 11 can be connected, so as to create an action that draws the label ribbon 7 back toward the inside of the suction chamber 21 and allows to bring the label ribbon 7 against the blade 20a, so as to cut the label ribbon 7 between two consecutive labels.

In this first embodiment, laterally adjacent to the conveyance drum 9 there is a glue spreading roller 22, which allows, upon the passage in front of it of a slider 11, to apply to the label ribbon 7 resting on said slider 11, with the trailing end and the leading end of two consecutive labels 7a, two strips of glue, respectively one at the trailing edge of a label 7a and the other at the leading edge of the subsequent label 7a.

In order to allow the application of the two strips of glue on the label ribbon 7, each slider 11 is, in this embodiment, provided with at least two portions which are more in relief than its remaining part, and more particularly with respect to the lateral surface 9a of the conveyance drum 9, which extend substantially parallel to each other and substantially parallel to the axis of the conveyance drum 9, so as to form, substantially, two ribs on the external surface 11a of the sliders 11.

At least one respective first resting region 12 is formed on at least one part of each one of said portions that are more in relief.

In greater detail, in this embodiment, in the central part of the external face 11a of each slider 11 designed to make contact with the label ribbon 7 or the labels 7a there are at least two first resting regions 12, arranged mutually side by side and placed on respective portions of the corresponding slider 11 that are more in relief with respect to the lateral surface 9a of the conveyance drum 9.

Again in this case, between these two first resting regions 12 and along the perimeter edges of the external face 11a of each slider 11 there are second resting regions 13, which protrude less from the lateral surface 9a of the conveyance drum 9 than the first resting regions 12.

Conveniently, besides being arranged at a greater distance from the axis of the conveyance drum 9 than the lateral surface of said conveyance drum, the first resting regions 12 of the sliders 11 are arranged, in this case, on surfaces which are substantially planar or, optionally, have less curvature than the lateral surface 9a of the conveyance drum 9, which are extended substantially parallel to the axis of the conveyance drum 9, while the second resting regions 13 arranged along the edges of the external face 11a of the slider 11 are instead arranged, preferably at least in their part that is closest to the first resting regions 12, on inclined surfaces, progressively toward each other starting from the axis of the conveyance drum 9 outward, thus creating a connecting bevel between the first resting regions 12 and the lateral surface 9a of the conveyance drum 9, while a second resting region 13 arranged between the two first resting regions 12 located in the central part of the slider 11 is arranged in a groove or cavity, which may be for example substantially V-shaped or U-shaped in transverse cross-section.

With reference to FIGS. 3 and 4, if, in this first embodiment of the machine according to the invention, the sliders 11 are provided according to their embodiment, with the presence of two different vacuum sources 14a and 14b or with the presence of a single vacuum source and two separate connections which serve, respectively, the first and the second vacuum chambers 17a, 17b, the first vacuum chamber 17a can be, in front view, substantially H-shaped, with two lateral portions which are substantially parallel to the axis of the conveyance drum 9 and which communicate with respective first suction openings 12a arranged at portions of the slider 11 that are more in relief, and a transverse portion which joins the two lateral portions.

FIG. 9 shows a second embodiment of the machine according to the invention, which is suitable for processing pre-adhesive label ribbons 7, i.e., ribbons already provided on the reel with strips of glue pre-applied to the leading and trailing ends of the individual labels 7a or optionally provided with a layer of glue on the entire surface of their face designed to be coupled to the containers 3.

In said second embodiment, the conveyance drum 9 is constituted by a cutting and transfer drum, provided with a plurality of cutting elements 23, designed to cut the label ribbon 7a, which are mutually circumferentially spaced along the peripheral region of the conveyance drum 9 and are controlled by respective actuation means 24, which comprise, for example, for each cutting element 23, a respective pneumatic or electronic piston, not shown.

Respective sectors of the conveyance drum 9 are formed in the circumferential portions between the cutting elements 23 and each one is designed to receive, in each instance, a single label 7a so that it rests thereon.

With reference again to this second embodiment of the machine according to the invention, for each sector of the conveyance drum 9 there are two sliders 11 arranged at the ends of the corresponding sector, so that each cutting element 23 is interposed between a respective pair of sliders 11, on which the trailing end of a label 7a arranged in one sector and the leading end of the immediately following label arranged in the contiguous sector are designed to rest, respectively.

In this case, the sliders 11 can each have at least one first resting region 12, conveniently arranged in a part of their external surface 11a that is central or, optionally, closer to the cutting element 23, and one or more second resting regions 13, at peripheral portions of their external face 11a.

Conveniently, the first resting region 12 is located at a portion of the corresponding slider 11 that is more in relief with respect to the lateral surface 9a of the conveyance drum 9.

FIG. 12 shows a third possible embodiment of the machine according to the invention, in which the conveyance drum 9 is constituted by a transfer drum which receives on its own peripheral surface the labels 7a cut by a cutting roller 25, fed by the unwinding assembly 6.

The cutting roller 25 supports, for example, a movable blade 25a, which is integral with the cutting roller 25 and cooperates with a stationary blade 25b, in order to cut the label ribbon 7.

In this case, the conveyance drum 9 is divided into one or more sectors or divisions 26a, 26b, each one of which is designed to receive from the cutting roller 25 a single label 7a.

Conveniently, the sectors 26a, 26b of the conveyance drum 9 are, mutually spaced by circumferential separation portions 27a, 27b and each has, at the respective ends, two sliders 11, respectively a leading slider and a trailing slider, along the direction of rotation of the conveyance drum 9, on which the leading end and the trailing end of the single label 7a received by each sector 26a, 26b are designed to rest, respectively.

In this embodiment also there is a roller 22 for spreading glue on the labels 7a, which is laterally adjacent to the conveyance drum 9.

In particular, the spreading roller 22 allows to apply, during the passage thereat of the sliders 11 of the sectors 26a, 26b, a respective strip of glue at the leading and trailing ends of the labels 7a which are resting on the sliders 11.

In this case, the sliders 11 of each sector 26a, 26b may conveniently have a first resting region 12, substantially in the central part of their external face 11a and at a portion thereof that is more in relief with respect to the lateral surface 9a of the conveyance drum 9, which is extended parallel to the axis of the conveyance drum 9, so that the spreading roller 22 can apply thereat a strip of glue on the labels 7a, and one or more second resting regions 13 arranged laterally to the first resting region 12 and less protruding from the lateral surface of the conveyance drum 9 than the first resting region 12.

The operation of the labeling machine, according to the invention, is as follows.

With reference to the first embodiment and in particular to FIGS. 6, 7 and 8, in a first step of operation the unwinding assembly 6 feeds the label ribbon 7 to the conveyance drum 9 at a speed that corresponds substantially to the peripheral speed of the conveyance drum 9.

In the situation shown in FIG. 6, a slider 11 of the conveyance drum 9 is in contact with the trailing end of a first label 7a of the label ribbon 7 and with the leading end of a second label 7a that directly follows the first label 7a along the label ribbon 7, and said slider 11 is in an angular position with respect to the axis of the conveyance drum 9, wherein it is substantially in front of the spreading roller 22, so that the spreading roller 22 can apply to the label ribbon 7 rested thereon a strip of glue at the trailing end of the first label 7a and a strip of glue at the leading end of the second label 7a.

In this angular position of the slider 11 mentioned above, its second resting regions 13 are activated, establishing a communication between their second suction openings 13a and the air suction means 14, so as to ensure, due to the greater attraction force applied by them, with respect to the first resting regions 13, to the label ribbon 7, the assured retention of the label ribbon 7 to the slider 11, so that the first and second label 7a of the label ribbon 7 resting on the slider 11 are perfectly integral with the rotation of the conveyance drum 9 during the application of the glue by the spreading roller 22.

In this situation, the first resting regions 12 of said slider 11 can be deactivated or, more preferably, can also be activated, so as to contribute, albeit with a lower attraction force than the second resting regions 13, to the retention of the label ribbon 7 on the slider 11.

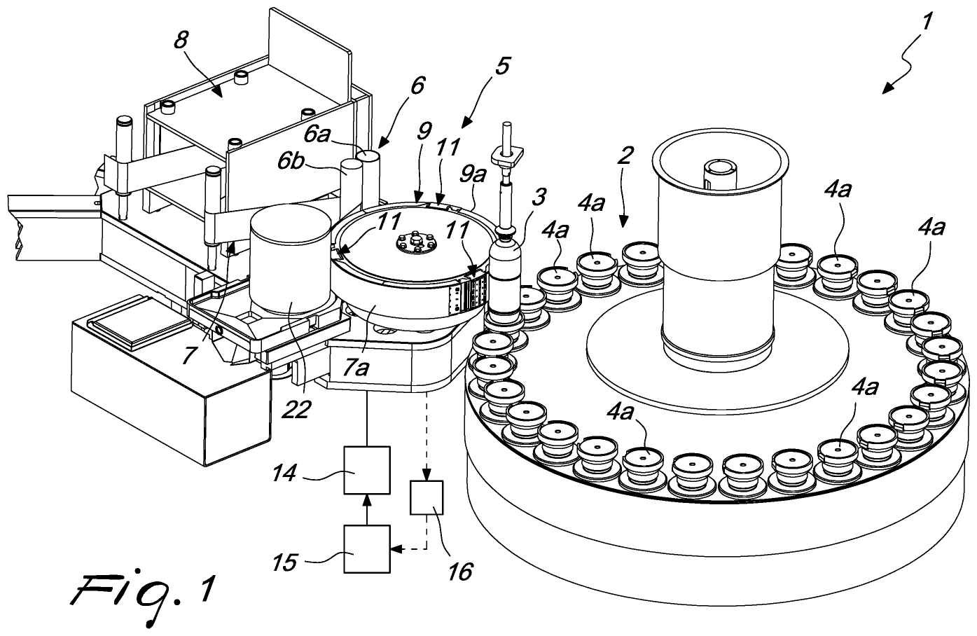

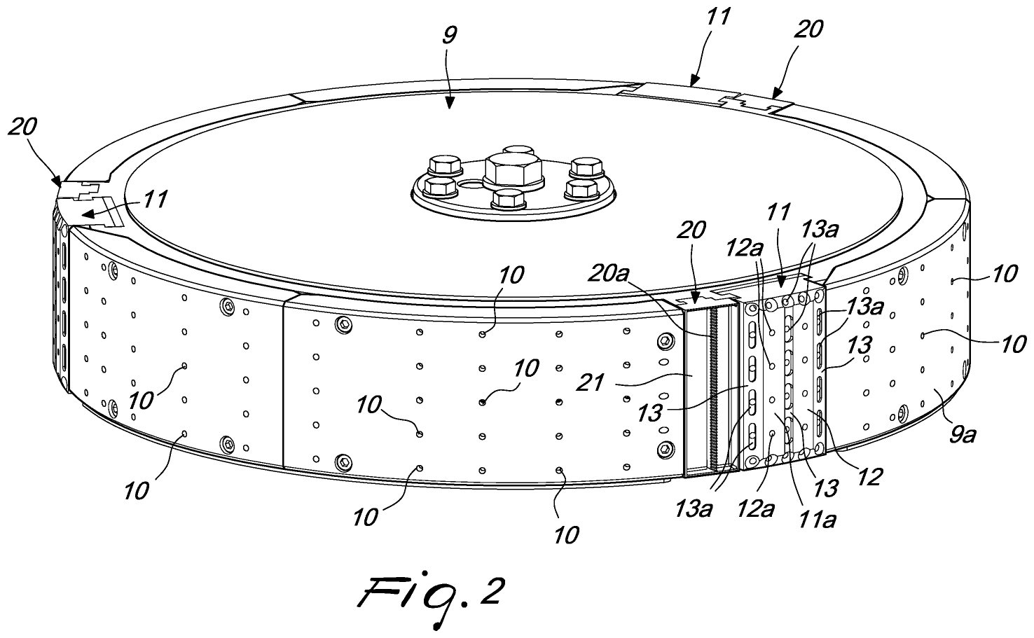

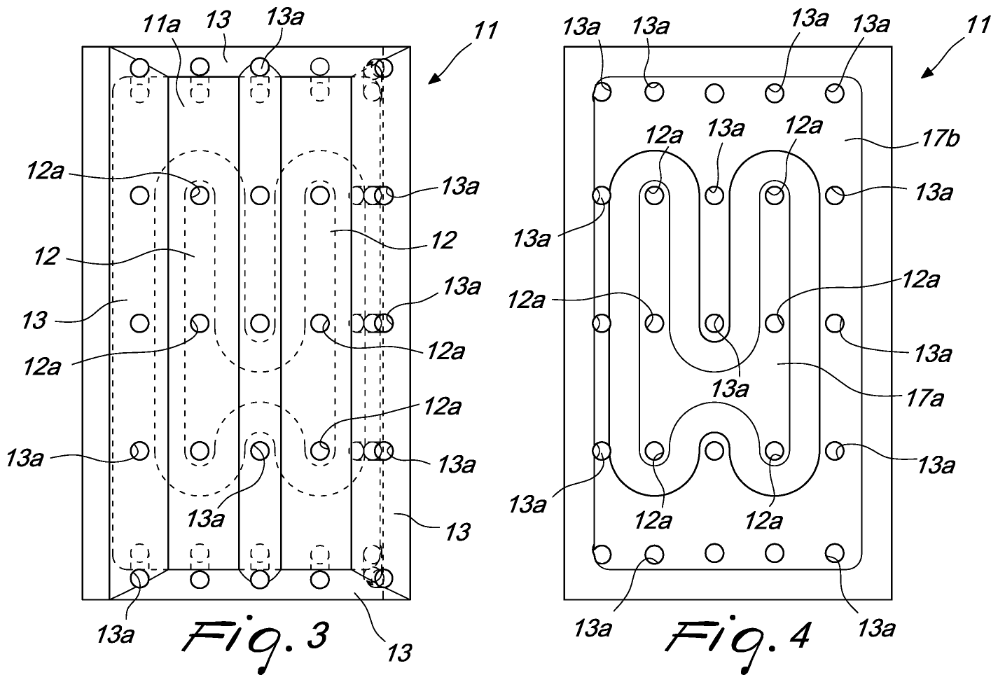

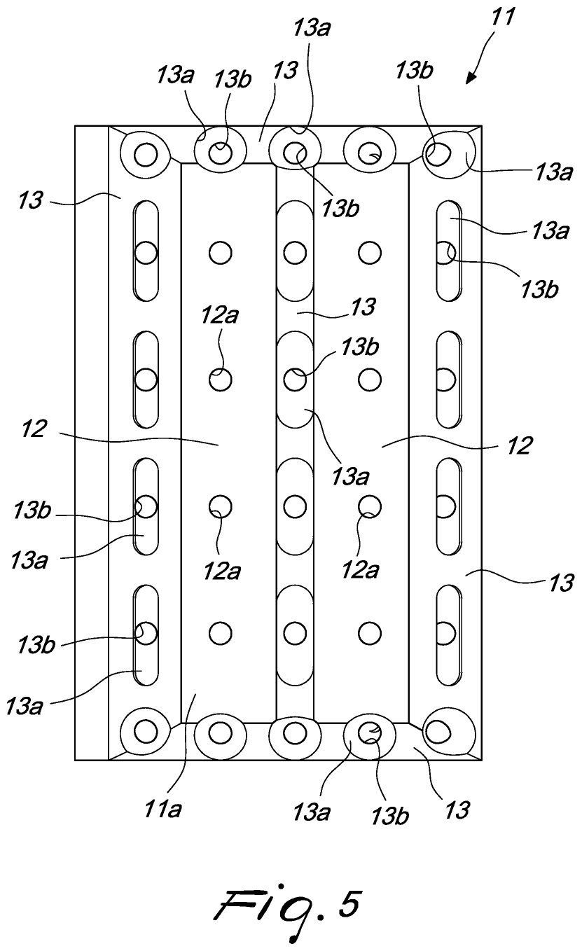

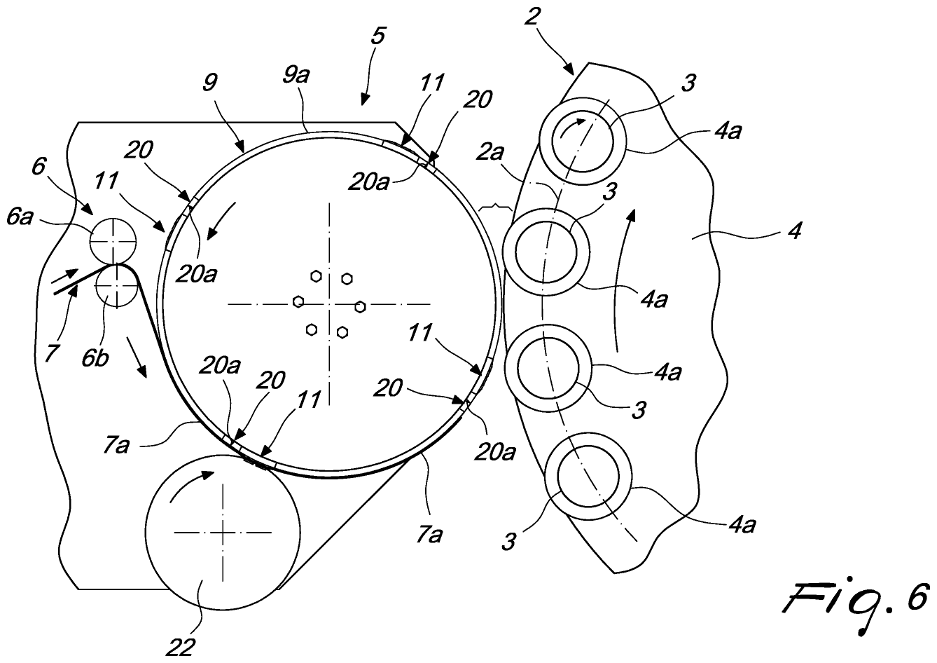

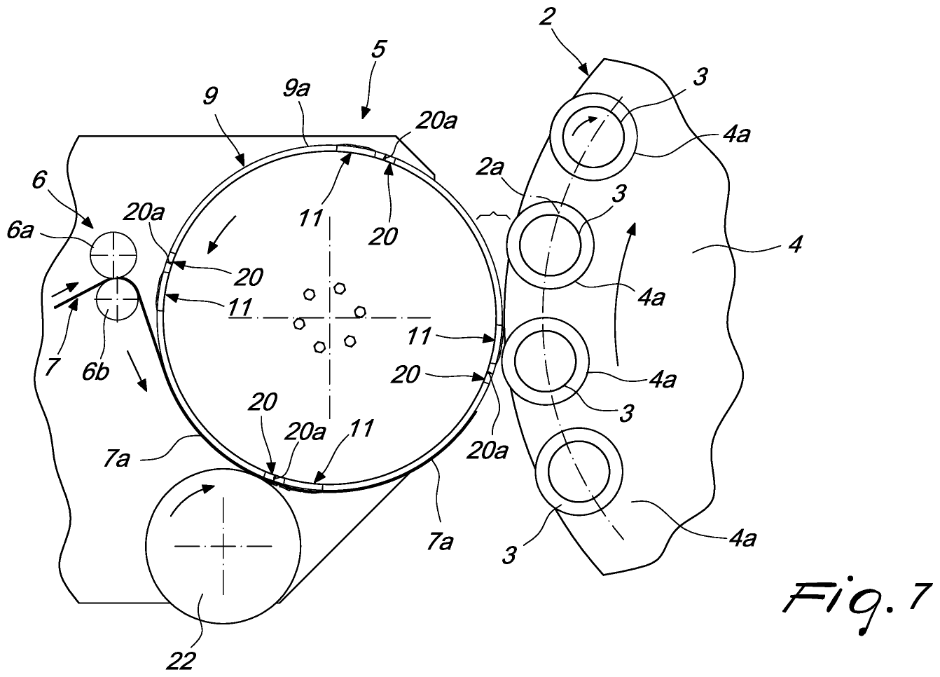

Once the glue has been applied to the trailing end and the leading end of the first and second labels 7a, respectively, one reaches the situation of FIG. 7, in which the unwinding assembly 6 feeds the label ribbon 7 at a lower speed with respect to the peripheral speed of the conveyance drum 9.

In this manner, the conveyance drum 9 can slide with its lateral surface 9a on the label ribbon 7, so as to bring at the separation region between the first and second labels 7a the cutting device 20 located directly behind, along the direction of rotation of the conveyance drum 9, with respect to the slider 11 that in the previous step was located at the spreading roller 22.

During the step of sliding on the label ribbon 7 of the conveyance drum 9 and, therefore, also of the slider 11 at which the glue has been applied, the second resting regions 13 of said slider 11 are deactivated, by interrupting the connection of its second suction openings 13a to the air suction means 14, while its first resting regions 12 are instead kept activated, so that the slider 11 can slide easily on the label ribbon 7, remaining adherent to it.

Of course, the first resting regions 12 as well may be deactivated by interrupting the connection of their suction openings 12a to the air suction means 14.

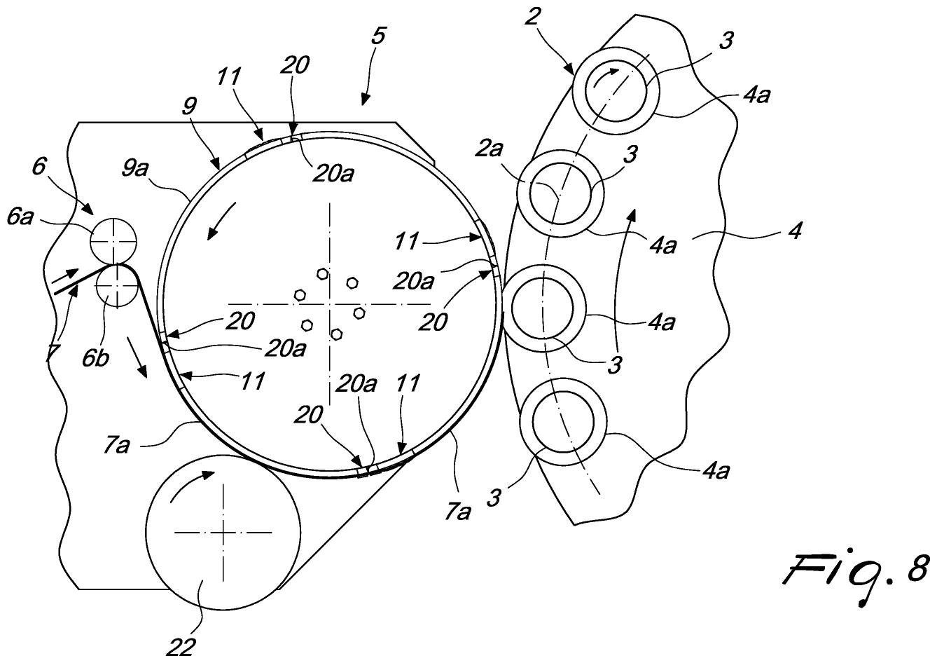

FIG. 8 shows the situation in which the cutting device 20 directly behind the slider 11 on which the trailing and leading ends of the first and second labels 7a were resting when the glue was applied to them has reached, with the corresponding blade 20a, the separation region between the first and second labels 7a.

In this situation, the label ribbon 7 is fed again by the unwinding assembly 6 at the same speed as the lateral surface 9a of the conveyance drum 9, and the second resting regions 13 of the slider 11 on which the trailing and leading ends of the first and second labels 7a were resting are activated again, thus ensuring that the label ribbon 7 is retained to the conveyance drum 9, so that it is perfectly integral with the movement of said conveyance drum, as a result of the greater attraction force applied by the second resting regions 13 with respect to the label ribbon 7.

At the same time, the suction chamber 21 of the cutting device 20 which is located at the separation region between the first and second labels 7a is also connected to the air suction means 14, so as to achieve the cutting of the label ribbon 7 between the first and second labels 7a by the cutting device 20.

The first label 7a thus cut from the label ribbon 7 will subsequently be delivered by the conveyance drum 9 to the respective container 3 conveyed by the conveyor 2.

With reference to FIGS. 10 and 11, it should be noted that in the operation of the second embodiment of the machine according to the invention there is a first step, shown in FIG. 10, in which the label ribbon 7 is fed to the conveyance drum 9 at a lower speed than the peripheral speed of said conveyance drum, so that the conveyance drum 9 can slide with respect to the label ribbon 7.

In this first step, the first resting regions 12, but not the second resting regions 13, of the pair of sliders 11 between which there is the cutting element 23 which, in this step, faces the label ribbon 7, are activated so that the sliding of said sliders on the label ribbon 7 is facilitated.

Once the cutting element 23 facing the label ribbon 7 reaches, as a result of the sliding of the conveyance drum 9 on the label ribbon 7, the separation region between two consecutive labels 7a present on the label ribbon 7, as shown in FIG. 11, the unwinding assembly 6 again feeds the label ribbon 7 at the same speed as the lateral surface 9a of the conveyance drum 9 and the second resting regions 13 of the sliders 11 between which there is the cutting element 23 that faces the label ribbon 7 are activated to create a high degree of vacuum and thus ensure that the label ribbon 7 is integral with the sliders 11 and, therefore, with the conveyance drum 9.

At this point, the cutting element 23 is actuated so as to cut the label ribbon 7, so as to separate from it a new label 7a, which is subsequently be delivered by the conveyance drum 9 to the corresponding container 3 transported by the conveyor 2.

With reference now to the third embodiment and, more particularly, to FIGS. 13, 14 and 15, it can be noted that in this embodiment there is a first step, shown in FIG. 13, in which a label 7a, supplied to the conveyance drum 9 by the cutting roller 23, is arranged at a first sector 26a of the conveyance drum 9 with its leading and trailing ends resting on the sliders 11 located at the ends of the first sector 26a and, more particularly, with its leading end located at the glue spreading roller 22, so as to receive from it a strip of glue, at the portion that is more in relief of the slider 11 on which it is rested, while another label 7a, which is located at a second sector 26b of the conveyance drum 9, may for example be in the condition of being able to be transferred onto the corresponding container 3 conveyed by the conveyor 2.

In this first step, the second resting regions 13 of the sliders 11 located at the ends of the sector 26a of the conveyance drum 9 are activated, so that the leading and trailing ends of the label 7a located at the sector 26a can adhere firmly to the sliders 11 on which they are resting, being perfectly integral with the motion of the conveyance drum 9.

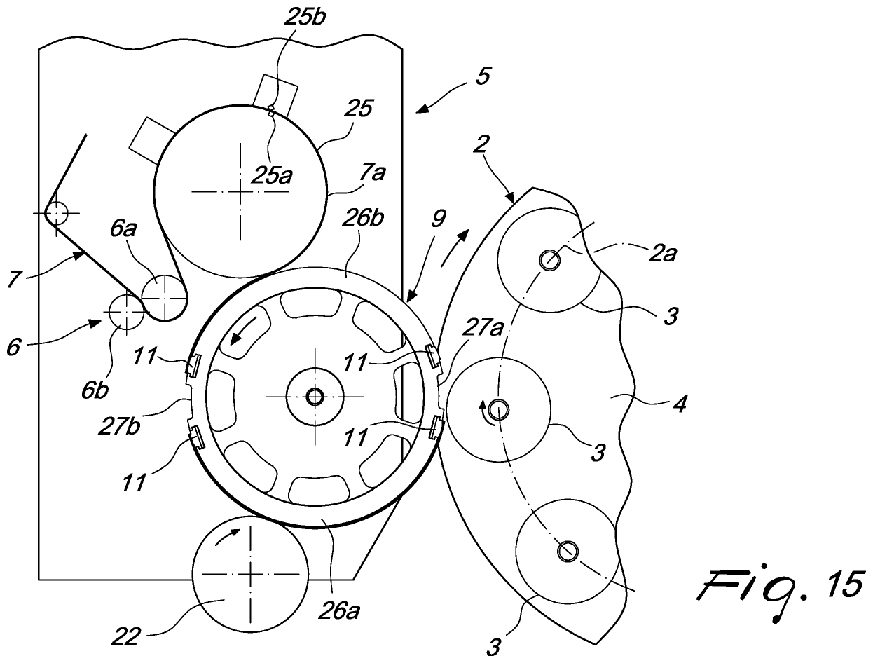

In a second step of the operation of the third embodiment, shown in FIG. 14, the second sector 26b of the conveyance drum 9, which during the preceding step transferred its label 7a to the corresponding container 3, is ready to receive from the cutting roller 25 a new label 7a, while the label 7a on the sector 26a continues its movement, entrained by the conveyance drum 9 to bring its trailing end at the spreading roller 22.

In this situation, the label ribbon 7, which has not yet been cut by the cutting roller 23, is fed by the unwinding assembly 6 to the cutting roller 23 and therefore also to the conveyance drum 9 at a speed that is lower than the peripheral speed of the conveyance drum 9, so that the conveyance drum 9 can slide over the label ribbon 7 to bring the leading slider 11 of the second sector 26b at the leading end of the new label 7a that the second sector 26b is receiving from the cutting roller.

In this step, the second resting regions 13 of the leading slider of the second sector 26b are deactivated, while only its first resting regions 12 are activated, so that the leading slider of the second sector 26b can rest on the label ribbon 7 while being able to slide easily on the label ribbon 7, at least until the leading slider of the second sector 26b reaches the leading end of the new label 7a that is supplied to it by the cutting roller 25.

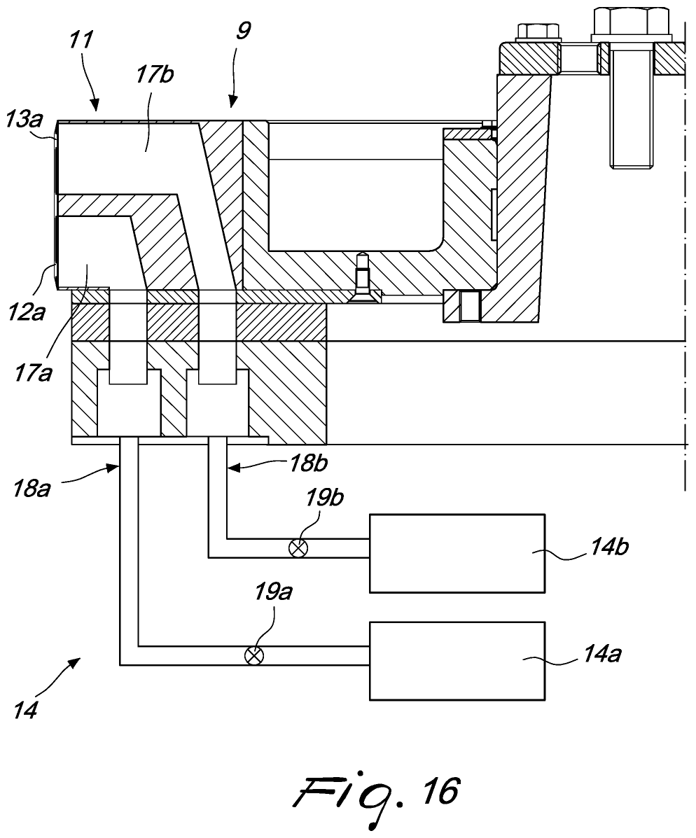

In the situation shown in FIG. 15, the leading slider of the sector 26b has reached the leading end of the new label 7a.

At this time, the label ribbon 7 is cut and at the same time the second resting regions 13 of the leading slider of the second sector 26b are activated, so as to make the label ribbon 7 adhere to the second resting regions 13 of the leading slider of the sector 26b, thus ensuring that the new label 7a can be cut validly from the label ribbon 7 and entrained by the conveyance drum 9, being perfectly integral with it.

Subsequently, the label 7a located at the first sector 26a is transferred to the corresponding container 3, after the trailing slider of the first sector 26a also has passed at the spreading roller 22, so that the trailing end of the label 7a arranged on the first sector 26a can also receive a respective strip of glue.

The invention thus conceived is susceptible of numerous modifications and variations, all of which are within the scope of the inventive concept; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102020000030809 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-14. (canceled)

15. A labeling machine, comprising a conveyor of containers to be labeled along an advancement path and at least one labeling assembly arranged along said advancement path, said labeling assembly comprising an unwinding assembly for a label ribbon, on which multiple labels are printed in succession, and at least one conveyance drum designed to receive on a lateral surface thereof said label ribbon and/or labels obtained by cutting said label ribbon, at a peripheral region of said conveyance drum there being a plurality of sliders, which are mutually angularly spaced around an axis of said conveyance drum and have at least one portion in relief outward with respect to the lateral surface of said conveyance drum, wherein at least one of said sliders has resting regions designed to engage by contact said label ribbon and/or said labels, which are adapted to apply, with respect to said label ribbon and/or said labels, mutually different attraction forces toward a corresponding slider of said sliders.

16. The labeling machine according to claim 15, wherein each one of said sliders is provided with said resting regions.

17. The labeling machine according to claim 15, wherein said resting regions comprise air suction means which are structured so as to allow said resting regions to generate, with respect to each other, a different degree or level of vacuum.

18. The labeling machine according to claim 17, wherein said suction means comprise, for each one of said resting regions, respective suction openings, which are formed on an external surface of the corresponding slider that is designed to receive by resting said label ribbon and/or said labels and is configured to be connected to the air suction means.

19. The labeling machine according to claim 18, wherein said resting regions comprise at least one first resting region, adapted to generate a first degree of vacuum, and at least one second resting region, adapted to generate a second degree of vacuum which is greater than said first degree of vacuum.

20. The labeling machine according to claim 19, wherein said first resting region is provided with first suction openings and said second resting region is provided with second suction openings.

21. The labeling machine according to claim 18, wherein said second resting region is arranged in a peripheral region of said external surface.

22. The labeling machine according to claim 19, wherein said first resting region is arranged at at least one portion of said external surface that is more in relief from the lateral surface of said conveyance drum, with respect to a remaining part of the corresponding slider.

23. The labeling machine according to claim 19, wherein said first resting region and said second resting region can be activated selectively on command in order to generate a respective degree of vacuum as a function of an angular position of the corresponding slider with respect to the axis of said conveyance drum.

24. The labeling machine according to claim 20, wherein said air suction means comprise at least two mutually different vacuum sources, adapted to create a respective degree of a vacuum, the suction openings of each one of said resting regions being configured to be connected to a respective vacuum source.

25. The labeling machine according to claim 24, wherein said air suction means comprise at least one first vacuum source, which can be connected to said first suction openings, and at least one second vacuum source, which can be connected to said second suction openings, said second vacuum source being adapted to generate a greater degree of vacuum than the degree of vacuum that can be generated by said first vacuum source.

26. The machine according to claim 20, wherein said air suction means comprise a single vacuum source, capable of generating a preset degree of vacuum, said first suction openings and said second suction openings being configured to be connected to said single vacuum source.

27. The machine according to claim 20, wherein said second suction openings have, at least at said external surface, a dimensional extent greater than a dimensional extent of said first suction openings.

28. The machine according to claim 23, further comprising control means, functionally connected to said air suction means and to at least one sensor for detecting the angular position of said sliders with respect to the axis of said conveyance drum, said control means being adapted to drive said air suction means, in order to actuate activation or deactivation of said resting regions on the basis of a signal that arrives from said at least one detection sensor.
